(19) United States
(12) Patent Application Publication
(10) Pub. No.: US 2022/0027936 A1
(43) Pub. Date: Jan. 27, 2022

(54) CREATING A COMMUNITY FROM DATA

(71) Applicant: KwikClick, LLC, Murray, UT (US)

(72) Inventor: Fred Cooper, Farmington, UT (US)

(21) Appl. No.: 17/372,134

(22) Filed: Jul. 9, 2021

Related U.S. Application Data
(60) Provisional application No. 63/049,864, filed on Jul. 9, 2020.

(51) Int. Cl. G06Q 30/02; G06Q 30/06; G06Q 50/00

(52) U.S. Cl. CPC G06Q 30/0214; G06Q 30/0205; G06Q 50/01; G06Q 30/0243; G06Q 30/0615; G06Q 30/0282

(57) ABSTRACT

Methods consistent with the present disclosure allow purchasers of a product to become a product distributor as part a multi-level marketing (MLM) organization. Once a person has purchased an item (a product or service) via their user device, they may be allowed to share information associated with the item with other user devices. These other user devices may be devices owned by members of a same social media group and the information shared with these other user devices may include materials that promote the sale of specific products. New users may be sent invitations to join an existing social media group, existing users may be sent invitations to join new or other social media groups, or both new users and existing users may be sent invitations to join particular groups based on these users being associated with a similar set of demographic data.

### CROSS-REFERENCE TO RELATED APPLICATIONS

The present disclosure claims priority benefit of U.S. provisional patent application 63/049,864 filed on Jul. 9, 2020 the disclosure of which is incorporated herein by reference.

### BACKGROUND OF THE INVENTION

### Field of Invention

The present disclosure is generally related to multi-level marketing systems and methods. More specifically the present disclosure is directed to providing product promotions, products, and commissions to related users.

### Description of the Related Art

A Multilevel marketing (MLM) commission payment system is a sales methodology used by some direct sales companies, which may be used to encourage existing distributors to recruit new distributors who are paid a percentage of their recruits' sales. The recruits are “downline” of the distributors. The term “downline” is used to describe sellers of products that have been sponsored by a sponsor (i.e. a sponsee of the sponsor) to sell products. The term “upline” is used to refer to sellers of products that sponsored a given sponsee. As such, sponsors are distributors that are upline from their sponsees and sponsees are distributors that are downline from their sponsors. Terminology used in the art refer to a recruit or a new person (i.e. distributor) sponsored by a sponsoring user is downline of the newly sponsored person, where the sponsoring user is “upline” of the newly sponsored person. Such persons or distributors also make money through direct sales of products to customers. Amway, which sells health, beauty, and home care products, is an example of a well-known direct sales company that uses multilevel marketing.

Multilevel marketing (MLM) has been found to be a legitimate business sales methodology if participants receive something of value for their participation in an MLM organization. Even though Amway has a pyramid like structure where sponsors may receive more benefits than new recruits, Amway has been judged to be a legitimate organization because all participants receive the benefit of purchasing products at a competitive price. One problem with some MLM organizations referred to as “pyramid schemes” is when new recruits do not receive any benefit based on just joining the MLM organization. One characteristic of a MLM “pyramid scheme” versus a legitimate MLM organization is that in a “pyramid scheme” new recruits receive benefits based primarily from signing up other new participants. Thus, money received from the new recruits only pays people above them or at the top of the organization rather than new recruits or others who actually perform work (e.g. the selling of products). As such, a “pyramid scheme” is also characterized by paying sponsors rather than individuals that perform the work. This is why “pyramid schemes” are illegal. These “pyramid schemes” involve taking advantage of people by pretending to be engaged in legitimate multilevel or network marketing activities, when their greater focus is on recruitment rather than on product sales.

One issue in determining the legitimacy of a multilevel marketing company is whether it sells its products primarily to consumers or to its members who must recruit new members to buy their products. If it is the former, the company is likely a legitimate multilevel marketer. If it is the latter, it could be an illegal pyramid scheme.

Each MLM company dictates its own specific financial compensation (or commission) plan for the payout of any earnings to their respective distributors. Compensation may be in the form of commissions that require a participant to enter a contract, pledging exclusivity in participation to the MLM company paying the commissions. Currently MLMs require that users become members in order to distribute a product and these users have no way to allow anonymous buyers to be part of a member's multilevel marketing group from which commissions may be earned. Compensation plans of MLMs pay out to participants typically from two primary possible revenue streams. The first is paid out from commissions of sales made by the participants directly to their own retail customers. Retail customers are not tracked or known by the MLM company therefore MLM companies cannot substantiate either their existence or their sales volume individually or collectively. The second is paid out from commissions based upon the wholesale purchases made by other distributors below the participant who have recruited those other participants into the MLM; in the organizational hierarchy of MLMs, these participants are referred to as one's downline distributors.

MLM salespeople (distributors) are, therefore, expected to sell specific MLM company products directly to end-user retail consumers by means of relationship referrals and word of mouth marketing, but most importantly they are incentivized to recruit others to join the company's distribution chain as fellow salespeople so that these can become downline distributors.

Currently, no large financially successful MLM salesperson (distributor) can earn commissions of any significance or take full advantage of a commission compensation plan without personally recruiting others into their downline.

All MLM compensation companies permanently place new recruits in a tree structure for calculating commissions. Once placed, all sales made by that distributor from their personal purchases, or from new recruits they sponsor, generate commissions only for their sponsor and upline, regardless of all future products sold.

MLM companies offer goods or services offered specifically and exclusively by them. The large markups required for payment of commissions necessitate MLM companies to limit what products they can offer such that they will be financially indifferent regarding which product a distributor chooses to buy.

MLM companies currently have a “pay to play” requirement. Distributors are required to make monthly purchases, and/or meet downline group sales volumes to qualify for commissions. Thus the mode, median and average purchase size of a Distributor in MLMs is virtually equal to this minimum qualification requirement and no greater.

Distributors only qualify for commissions if they have purchased a minimum threshold of products offered exclusively by the MLM company as set forth by an MLM company's commission program rules.

Currently, in order to join an MLM organization, there is an initiation fee, which may be a barrier against those that just wish to refer a single product they like. Current multi-level marketing (MLM) systems do not take full advantage of the internet and how consumers can influence other consumers to make purchases. Also, current MLM systems do not incorporate incentivizing users of a multilevel marketing system by offering a dynamic commission tree. In addition, there is no current MLM system that utilizes the money or funds dedicated to discounts or coupons to be reincorporated into a multilevel marketing system to incentive consumers to make purchases and advertise the product that they purchased. Thus, there is a need to provide users a method to join an MLM for free, being simple to use and allow the MLM commissions provided to purchasers, provided by the sellers to allow the purchasers to market the seller's products.

Currently, a company that is not utilizing an MLM structure for paying commissions for sales, cannot introduce one without developing a compensation plan specific for their company, following the methodology outlined above, and thus requiring them to become and subsequently adhere to applicable MLM law.

Current MLM organizations also do not allow their members to create marketing materials that may help motivate other individuals to join the MLM organization or to motivate members to purchase products offered for sale by the MLM organization. What are needed are new types of systems and apparatus that allow MLM members create and share marketing materials. What are also needed is the ability to propagate sales of products without the need for participants to identify themselves.

Further, there is currently no systematic way for consumers to promote any brand of preference outside the MLM industry and be paid in an MLM commission methodology without subjecting themselves to a contractual signup, initiation fees, minimum recurring purchases sales, volume requirements, recruiting, exclusivity, and permanent tree placement (resulting in only upline distributors earning commissions). In recent years, communications via social media on the Internet has grown dramatically. Social media group, however, have not been used to promote sales of a MLM organization.

This system has value because it allows users to become a part of the MLM system simply by clicking a referring link and buying the product. What are needed are systems where a user does not need to be referred to be able to refer the product to others. In addition, users can propagate the product without ever identifying themselves and collecting their commission.

What are also needed are methods that allow members of social media groups to sell products to associated or like-minded individuals.

### SUMMARY OF THE PRESENTLY CLAIMED INVENTION

The presently claimed invention is directed to a method that may be implemented as a non-transitory computer-readable storage medium. In one embodiment, a method includes identifying that a user has provided authorization to purchase a product, comparing product sales data of the product with product sales threshold data associated with the product, and identifying that a sales threshold has been met after comparing the product sales data with the product sales threshold data. Here the authorization may have been received from a user device based on user input received by the user device. Next, an invitation may be sent to the user device identifying a social media group that the user can join, the social media group may have been identified according to a group assignment rule based on the meeting of the sales threshold. This method may also include receiving a data from the user device indicating that the user has agreed to join the social media group. This user may be associated with the social media group according to the group assignment rule and the product may be provided to the user based on the authorization to purchase the product.

In a second embodiment, methods of the presently claimed invention may be implemented by a processor that executes instructions out of a memory. Here again the method may include identifying that a user has provided authorization to purchase a product, comparing product sales data of the product with product sales threshold data associated with the product, and identifying that a sales threshold has been met after comparing the product sales data with the product sales threshold data. The authorization may have been received from a user device based on user input received by the user device. Next, an invitation may be sent to the user device identifying a social media group that the user can join, the social media group may have been identified according to a group assignment rule based on the meeting of the sales threshold. This method may also include receiving a data from the user device indicating that the user has agreed to join the social media group. This user may be associated with the social media group according to the group assignment rule and the product may be provided to the user based on the authorization to purchase the product.

### BRIEF DESCRIPTION OF THE DRAWINGS

FIG. 1 illustrates different sets of computer systems that may be included in a computer networked multi-level marketing system.

FIG. 2 illustrates steps that may be performed when products associated with a multilevel marking (MLM) organization are sold by or to members of a social media group.

FIG. 3 illustrates steps that may be performed when a determination relating to whether a new group of a multilevel marketing (MLM) social media sales organization should be created.

FIG. 4 illustrates a series of steps that may be performed when evaluations are performed that identify whether invitations should be sent to user devices of present users or new users of a multilevel marketing (MLM) organization.

FIG. 5 illustrates a computing system that may be used to implement an embodiment of the present invention.

### DETAILED DESCRIPTION

Methods consistent with the present disclosure allow purchasers of a product to become a product distributor as part a multi-level marketing (MLM) organization. Once a person has purchased an item (a product or service) via their user device, they may be allowed to share information associated with the item with other user devices. These other user devices may be devices owned by members of a same social media group and the information shared with these other user devices may include materials that promote the sale of specific products. New users may be sent invitations to join an existing social media group, existing users may be sent invitations to join new or other social media groups, or both new users and existing users may be sent invitations to join particular groups. A user may be invited to join a specific group based on types of products that they purchased or based on characteristics that they share with other members of a social media group.

This process may allow users to select products offered for sale by the MLM organization after which hyperlinks may be generated that are associate a universal resource locator (URL) with item identification and referral information. When a user device accesses the hyperlink, that user device may access a computer that collects data regarding user access. This computer may then redirect the user device to a webpage identified by the URL that sells the item. When a user purchases the product, commissions may be paid out to a set of related distributors that previously purchased the product. These distributors may be related by referral information that is a chain or tree of distributor users that each referred information for purchasing the item to another one of the user/distributors that are part of the same chain or tree of distributor users.

This may be accomplished by providing materials to potential buyers that allow those potential buyers to quickly link to product offerings. This may include associating a product with a hyperlink and with one or more users that participate in multilevel marking activities, when new users or new products are enrolled as part of an MLM organization.

The present disclosure is also directed to a system and method to allow sellers of products to enroll an individual product in a multilevel marketing (MLM) type commission system (system), where a good or service (i.e. product) is offered by any vendor and sold to a first purchaser—who at the time of the purchase becomes a system user (or registered user/participant/distributor). This user has a code tied to the specific product(s) offered by the participating vendor. The code may be shared by this first user passively (by a purchase) or actively (by request) to a new buyer. The code share makes the new buyer a user of the system. The new user, like the first, will be allowed to purchase the product and provide advertisements to other purchasers. Commissions paid to respective downline purchasers for a single product may be limited by a preset number of defined levels. After a product is purchased, commissions are paid out to each respective purchaser according to the defined commission levels. A wave of creating and recreating users may be based on purchases and linking them together may be part of an iterative process. Remuneration on this specific product is paid to all or numerous users linked together in the system, each time a purchase is made. The links may be unique and fixed to each good or service being referred.

Once a new buyer purchases a product, that new user may also be assigned a unique code that may be considered a child code of a parent code that is assigned to a user that provided the new buyer with materials that promote the purchase of the product that they purchased. The parent code may be shared by a first user passively (by a purchase) or actively (by sending a request) to the new buyer. This type of code sharing makes the new buyer a user of the system. The new user, like the first user, will be allowed to purchase the product and provide advertisements to other purchasers. New users may also be allowed to create new product offerings. Commissions paid to respective upline or downline purchasers for a single product may be limited by a preset number of defined levels. After a product is purchased, commissions may be paid out to each respective purchaser according to the defined commission levels. A wave of creating and recreating users may be based on purchases and linking them together as part of an iterative process. Remuneration on this specific product is paid to all or numerous users linked together in the system, each time a purchase is made. The links may be unique and fixed to each good or service being referred. Payments may be distributed directly into a back account of a user, as credits to a mobile device, as credits to a credit/cash/debit card, may be distributed using a form of cryptocurrency, or may be distributed by other means.

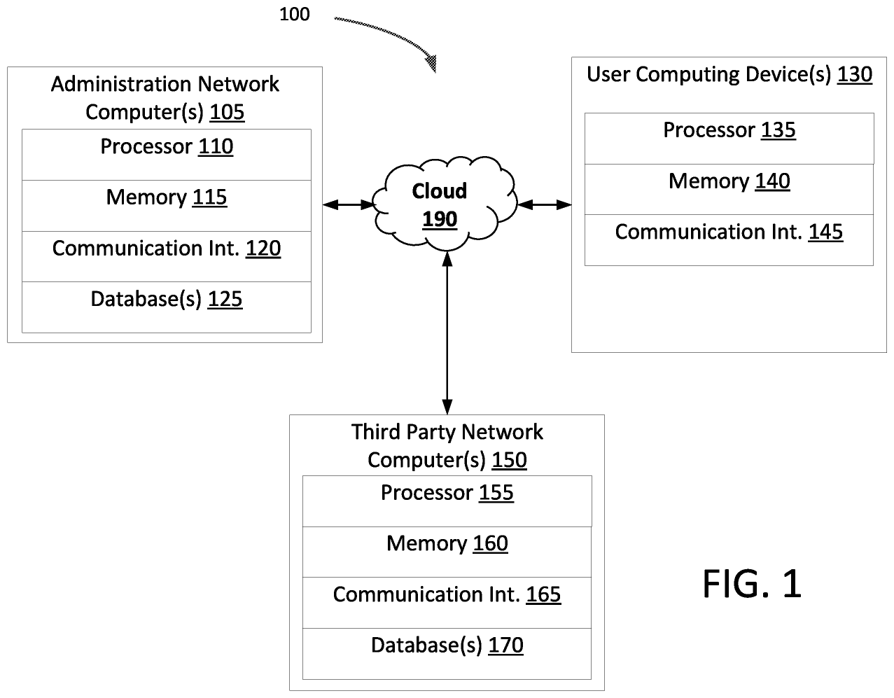

FIG. 1 illustrates different sets of computer systems that may be included in a computer networked multi-level marketing system. The various computers of FIG. 1 may implement functions consistent with a multilevel marketing (MLM) system 100 or MLM organization. FIG. 1 includes one or more administration computers 105, user computing devices 130, and third party network computers 150 that may communicate via the Internet or a cloud computing environment 190. Each of the different computers of FIG. 1 may include a processor, a memory, and a communication interface. Some of the computers illustrated in FIG. 1 include one or more databases where data relating to the operation of MLM system 100 may be stored. In operation, each of the respective computers of FIG. 1 may execute instructions out a memory local to that processor and may communicate with other computers via a respective communication interface when products are added to or sold by members of a MLM organization.

Administration computer 105 includes processor 110, memory 115, communication interface 120, and database(s) 125. User computing device 130 includes processor 135, memory 140, and communication interface 145. Third party network computer 150 includes processor 155, memory 160, communication interface 165, and database(s) 170. A user of user device 130 may interact with a user interface (not illustrated) at user device 130 when accessing information stored at administration network computer 105 database(s) 125 or when accessing information stored at third party network computer 150 database(s) 150. Such interactions may allow a user to identify products that they can sell, identify new users, and receive information identifying information relating to products they distribute as a member of an MLM organization.

Processor 110 of administration network computer 105 may execute instructions from one or more software modules when functions associated with the registration of new products and users, the sale or distribution of marketing materials, or when commissions are distributed to users that act as distributers (or sales representatives) of products. When software program code executed by processor 110 is organized as a set of multiple different software modules, those modules may include an administration network base module, an administration network calculation module, an administration network commission module, an administration network advertising module, a social media base module, a software module for setting up social media groups, and a software module that invites users to join a group. Computers 105 of an administration network may include or access one or more databases that may include a social media group database, a transaction database, and a social media group rules (or rules) database.

A user or distributor may refer to the non-salaried workforce selling the company's products or services, while the earnings of participants of an MLM organization may be associated with a pyramid-shaped or binary compensation commission system. A product may refer to an article or substance that is manufactured or refined for sale. A service may refer to a system supplying a public need such as transport, communications, or utilities such as electricity or water. A service may be an act of dealing with a customer in a store, restaurant, or hotel by taking their orders, showing, or selling them goods. Additionally, a service may be work that someone does or time that someone spends working for an organization, or a business that offers a particular type of help or work.

The administration network computer 105 may accept sellers (third parties), where a “single product tree” multi-level marketing method is formed, comprising the steps of, providing at least one product, providing an MLM system with a seller's commission structure, and providing at least one seller of a product with its associated commission structure. The term “single product tree” or “product tree” refers to a unique structure for associating distributors of an MLM organization where products are used to identify relationships between distributors and commissions paid to related distributors. This “single product tree” structure allows for a particular user to be considered a sponsor or any other user based on that user sending promotions to other users to purchase a product that those other users were not previously associated with.

The administration network computer 105 may also provide a plurality of buyers/distributors, allow the at least one first seller to enroll a product to the MLM system, and allow at least a first buyer/distributor to purchase the product. Other functions that may be performed by the administration network computer 105 include allowing the at least the first buyer/distributor to advertise the product to other potential buyers/distributors and allowing at least a second buyer/distributor to buy the advertised product. Here the seller may set a commission structure for a product, may enroll the product into the MLM system, may allow the first, second and so on purchasers/distributors to purchase and advertise the product.

Instructions of an administration network product enrollment software module may allow users to create a first referral code that may be stored at a database 125 of FIG. 1. Such a database may be referred to as an administration network hyperlink database. Instruction of an administration network hyperlink creating module may allow users to create a hyperlink by combining the user specific referral code, discussed above, with information of what may be referred to as a “landing page.” Such a “landing page” may be webpage hosted at third party network computer 150 and that landing page may include information associated with purchasing a product or purchasing a product at discount rate. This landing page data may be accessed by or copied to an administration network computer 105. In certain instances, a discount may be applied based on a code that is provided to the third party network computer 150 via a specific landing webpage. A prospective buyer may be allowed to enter a code via a user interface associated with the landing webpage or a code may be received automatically after a user selects (or clicks on) a referral hyperlink at their user device. Alternatively, or additionally, such landing pages or landing webpages may be hosted by administration network computer 105.

Functionality of a landing webpage may be invoked after a referral or set of marketing materials are displayed on a display of a user device. These materials may include a universal resource locator (URL) or an embedded URL that when selected results in a browser of the user device to receive content of the landing webpage. Here, a code may be entered by a user to gain a discount or that code may be automatically provided to the landing webpage and the user device may be sent a discount offer to purchase a product. This offer may be displayed on a display of the user device and a user by interacting with their user device may order the product. Once purchased and potentially after the user receives the ordered product, commissions may be paid to upline members of an MLM organization that are associated with the user that purchased the product. Marketing materials provided to users via their user devices may include various types of media, such as photos, videos, text, sounds, haptics, online product descriptions, etc. for enhanced marketing.

Once products have been enrolled with a commission structure, the administration network computer 105 may allow the purchasers/distributors to receive a commission based upon the seller's product commission structure. A distributor may refer to the non-salaried workforce selling the company's products or services. Here the earnings of the participants may be derived from a pyramid-shaped or binary compensation commission system. The term product may refer to articles or substances manufactured or refined for sale. Product may refer to an individual product, a line of products such as unique brand and model of drill, or a group of products such as all power tools.

A service may refer to a system supplying a public need such as transport, communications, or utilities such as electricity or water. A service may also be an act of dealing with a customer in a store, restaurant, or hotel by taking their orders, showing, or selling them goods. Additionally, a service may be work performed by a person or may relate to an amount of time that someone spends working for an organization or business that offers a particular type of help or work. The system 100 of FIG. 1 may distribute commissions according to an MLM tree or commission tree that is a payment structure in which commissions are given out at different percentages at different levels of the MLM tree. In such a system, distributors (users) that perform the sale or that are at a level that is “closer” to the distributor that performed the sale may receive larger commissions than distributors that are “farther” from the sale.

In another example, a first MLM distributor that performs a sale may receive a higher percentage than a second distributor that sponsored the first MLM distributor, and a third MLM distributor that signed up the second MLM distributor may receive a lower commission than the commission received by the second MLM distributor for the sale. Distributors in an MLM tree may be referred as “downline” or “upline” distributors depending on where different users rank on the MLM tree.

For example, a first user that sponsors (MLM distributor) a second user is “upline” from the second user (MLM distributor) and the second user is “downline” from the first user in the MLM tree. Furthermore, any user/distributor that the second user sponsored would be considered downline from the second user and could be downline from the first user as well for a given MLM product tree. When a “single product tree” structure is used to identify commissions, users that are downline from the second user may not be downline from the first user based on the second user purchasing and advertising products not associated with the first user. When the first user purchases the product initially advertised by the second user, the second user may be considered upline of the first user after the first user for this product. Because of this, the second user is not relegated to always be downline from the first user just because the first user originally sponsored the second user to become an MLM distributor.

An MLM system which may be referred to as network marketing, may be a business model that depends on person-to-person sales by independent representatives, who may work from their home. A network marketing business may require the independent representatives to build a network of business partners or salespeople to assist with lead generation and closing sales. An end of life of MLM tree may refer to the end of the MLM tree in which the commission tree may be restructured or eliminated. For example, further participants in the MLM may not receive a commission, the commission tree may “start up” (be reinitiated from a starting point) again, or the commission tree may be restructured in some other way. An existing MLM system may refer to currently existing or established companies that use the sales strategies to encourage existing distributors to recruit new distributors who are paid a percentage of their recruits' sales.

The administration network computer 105 may perform data security functions as well as functions associated with operation of an MLM algorithm that may calculate user compensation. Administration network computer 105 may be able to connect to a software application store, like the “Apple App Store,” where a program application can be downloaded from. Data security may refer to the process of protecting data from unauthorized access and data corruption throughout its lifecycle. Data security may include data encryption, tokenization, and key management practices that protect data across all applications and platforms. An MLM algorithm may refer to a calculation performed using a compensation decay rate to calculate the commissions for downline participants.

A set of commission program instructions may cause a computer processor 110 at the administration network computer 105 to continuously poll for user data (e.g., data of a user who may be a product purchaser or product distributor) from another processor executing a set of discount program instructions at a third party network computer 150. Once the processor 110 of the administration network computer 105 receives the user data, commissions may be calculated using the commission program instructions. These commissions may be calculated based on data stored in an administration network compensation database. Downline and upline commissions for the other users (product purchasers/distributors) within the MLM tree may be paid. The administration network compensation database may be included within the administration database 125 of FIG. 1 or it may be a separate database accessible by the administration network computer 105. Alternatively, instead of the administration network computer 105 polling a third party network computer 150, the third party network computer 150 may send the user data to the administration network computer 105 after a sale has been made.

An upline may refer to the MLM distributors that recruits work for as salespeople to sell the products or services. A downline may refer to the recruits the MLM distributors are able to secure as participants in the MLM system. Downline MLM trees may go across country boundaries and commissions may be paid out for an MLM tree even though the participants in the MLM tree may not reside in the same country. The commissions may be calculated for the appropriate exchange rate to ensure participants are paid in their residing countries currency in the correct amount.

A processor executing the commission program instructions may continuously poll for user data from the third party network computer 150. The administration network computer 105 may then receive the user data from the third party network computer 150. Then the administration network computer 105 may determine whether the user entered a code. If the user did enter a code, the processor at the administration network computer 105 may extract the code and then access the administration network compensation database to identify one or more different spheres of influence or potential product purchasers/distributors levels. Such a code may have been received from user device 130 based on user inputs. A sphere of influence for a given product may be associated with a chain of upline and downline distributors that sold a particular product, where each downline user may have been sponsored to sell the product by an upline user.

The processor 110 at the administration network computer 105 may also associate a code for each of the different spheres of influence. The administration network computer 105 may then extract a corresponding commission for the code that was retrieved from in the administration network compensation database. The administration network computer 105 may then send the commission to the user (purchaser/distributor) via communication interface 120 and the Internet or cloud 190. The administration network computer 105 may track profits and payments as well as track taxes for users enrolled in the MLM system. The tracking of profits and payments may refer to the MLM system tracking the profits of the MLM and tracking the payments or commissions paid out to participants. The tracking of taxes may refer to tracking the commissions provided to participants for tax purposes. Then the administration network computer 105 may also compare the extracted code to data stored at an administration network code database that may store a list of users and code sent to followers. This administration network code database may be the same database as the administration database 125 of FIG. 1 or it may be another database accessible by the administration network computer 105. The administration network computer 105 may extract a user ID and sphere of influence or potential purchasers/distributors by using the extracted code.

The administration network computer 105 may then compare the extracted sphere of influence or potential purchaser/distributor to data stored at the administration network compensation database. The administration network computer 105 may then use the extracted sphere of influence data to extract a corresponding commission from the administration network compensation database. The administration network computer 105 may then send the commission to an upline user. If the user did not enter a code, the administration network computer 105 may then initiate a set of administration network advertising program instructions.

The administration database 125 may store data received from various third parties (various sellers) that are part of a set of MLM trees. This data may contain an item ID, description of the item, an original cost of the item, a discount for the item, a cost of the item with the discount, a compensation plan decay rate, and a link to the item. An advertising link may refer to a link that directs a consumer to a product, service or good.

TABLE 1
Administration Database Data

| Third Party | Home Depot | Home Depot | Furniture Store |
|---|---|---|---|
| ID | 654123 | 789654 | 123789 |
| Item | Drill | Table Saw | Couch |
| Original Cost | $59.00 | $119.00 | $999.00 |
| Discount | 15% | 10% | 10% |
| Discount Cost | $50.15 | $107.10 | $899.10 |
| Compensation | 50% | 50% | 30% |
| Decay Rate | | | |
| Link | HDDrill654123 | HDTSaw789654 | FSC123789 |

Table 1 table displays data that may be stored at the administration database 125 of FIG. 1. When the administration network computer 105 receives item data from third party network computer 150 it creates a link for the item, stores the received data in the administration network administration database 125, and sends the created link back to the third party network computer 150. The administration network database 125 may be used to store data collected from various third parties that enrolled in the multi-level marketing system 100 of FIG. 1. The administration network database 125 may store the name of the third party, the ID for an item, a description of the item, the original cost of the item, the discount provided by the third party, the cost of the item with the discount, the compensation decay rate or how the downline commissions are calculated, and the link to the item.

The administration database 125 may store data that the administration network computer 105 may access when communicating events with the downlines and uplines, providing dynamic incentives or rewards for a product, distributing marketing materials, providing banking referrals, or distributing materials for suggestive selling, etc. Here, communicating events with downlines and uplines may refer to sending information relating to advertising events to participants of an MLM system. Dynamic incentives and rewards for a product may refer to incentives or rewards that are continuously updated for a product. Marketing materials may refer to a means of marketing, advertising or promotional materials developed by or for license (or subject to licensee's approval) that promote the sale of the licensed product, including but not limited to, television, radio and online advertising, point of sale materials (e.g., posters, counter-cards), packaging advertising, print media, and all audio or video media. Banking referrals may refer to a structured flow of collecting and organizing referrals for banks. Businesses who have been unsuccessful in a credit application process with a bank may be asked for their permission to have their financial information passed to designated finance platforms who can contact the business in a regulated timeframe. Suggestive selling may refer to a sales technique where an employee asks a customer if they would like to include an additional purchase or recommendation a product which might suit the client.

As mentioned above user device 130 may include a memory 140, a processor 135, and a communication interface 145. The processor 135 of user device 130 may execute instructions out of the memory 140 when a user of user device 130 registers as a member of an MLM organization. Other tasks that a user may perform on user device 130 could include, identifying or connecting with other user devices (e.g. follower user devices), preparing advertisement information to share with follower user devices, receiving advertisement information prepared by other users, accessing product promotions at the third party network computer 150, and purchasing products based on offerings received from the third party network computer 150. Each of the tasks performed by user device 130 may include sending and receiving communications with the administration network computer 105, the third party network computer 150, or other user devices. Promotions prepared at a particular user device may be shared with other user device via administration network computer 105, third party network computer 150, a social media network computer, or directly from one user device to another. User devices may also be required to download and install an application program from an application store, such as the “Apple App store” as part of a process for registering as a member of an MLM organization.

The user device communication interface 145 of FIG. 1 may send and receive data via a communication network 190 which may be a wired and/or a wireless network. User device(s) 130 may be devices such as a laptop computer, a smartphone, a tablet, a desktop computer, or smart speaker, for example.

As discussed above the third party network computer 150 of FIG. 1 may include a computer processor 155, a memory 160, and communication interface 165. This third party network computer 150 may be controlled by various third parties, such as retail stores (stores that sell product consumables, services, franchises, service networks, large box stores) or e-commerce sites that allow e-commerce sales. Such e-commerce sites may include an e-commerce shopping cart, that offer items to users at a discount, such as a product discount, in order to use the MLM system of FIG. 1. A franchise may refer to an authorization granted by a government or company to an individual or group enabling them to carry out specified commercial activities, e.g., providing a broadcasting service, or acting as an agent for a company's products. Product consumables may refer to goods by individuals and businesses that must be replaced regularly because they wear out or are used up. Service networks refer to a collection of people and information brought together on the internet to provide a specific service or achieve a common business objective, such as Angie's List. E-commerce sale may refer to sales of goods and services where the business takes place over the internet, an extra-net, Electronic Data Interchange (EDI), or other online system.

Payment may or may not be made online. Business in this context may be defined as an order placed by the buyer or price and terms of sale negotiated. E-commerce shopping cart may refer to a software used in E-commerce to assist visitors to make purchases online. Upon checkout, the software calculates the total of the order, including shipping and handling, taxes and other parameters the owner of the site has previously set. Retailer may refer to a person or business that sells goods to the public in relatively small quantities for use or consumption rather than for resale. Product discounts may refer to a reduced price or something being sold at a price lower than that item is normally sold for. It is a reduction to a basic price for a good or service. Large box stores may refer to a physically large retail establishment, usually part of a chain of stores, offers a variety of products to its customers. The term sometimes refers, by extension, to the company that operates the store, and which may be referenced as a supercenter, superstore, megastore, etc. These stores achieve economies of scale by focusing on large sales volumes. Because volume is high, the profit margin for each product can be lowered, which results in very competitively priced goods. The term “big-box” is derived from the store's physical appearance.

The third party network communication interface 165 of FIG. 1 may send data and receive via a communication network 190 which may be a wired and/or a wireless network.

The third party network discount program instructions may be executed by a computer processor 155 after being initiated by a set of third party network base program instructions. These instructions may cause the processor 155 at the third party network computer 150 to prompt a user device for a discount code and to compare a received code to data stored at a third party network third party database 170. When a code received from a user matches data stored at the database 170, a discount for the selected item may be applied and an order for a product may be processed.

The communications network 190 of FIG. 1 may be the Internet or a cloud computing network. This communication network or any of the communication network interfaces 150 or 170 discussed herein may be a wired and/or a wireless network. Such a communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance.

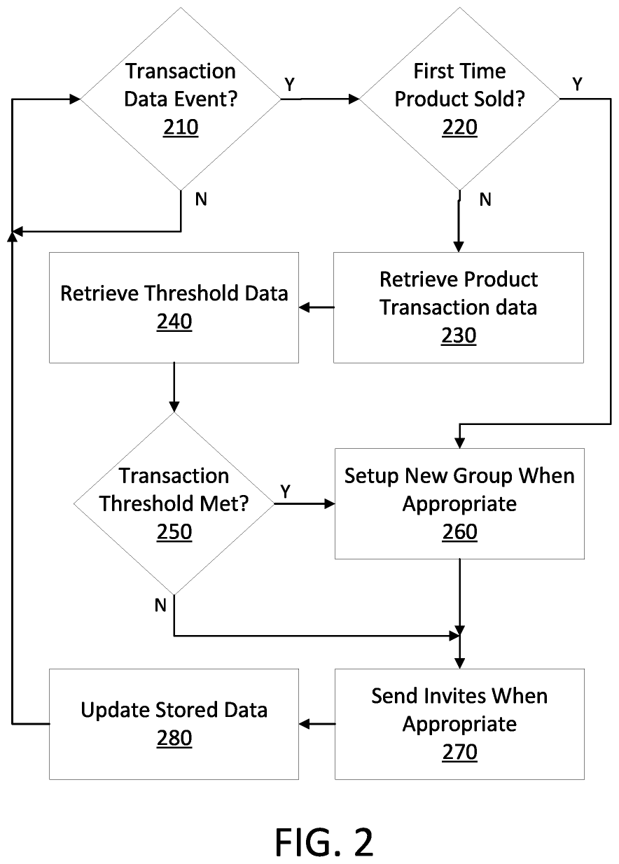

FIG. 2 illustrates steps that may be performed when products associated with a multilevel marking (MLM) organization are sold by or to members of a social media group. The steps of FIG. 2 may be performed by an administration computer, such as the administration network computer 105 of FIG. 1. The steps of FIG. 2 may identify when new social media groups should be created or when invitations should be sent to users that are purchasing a product. FIG. 2 begins with determination step 210 that identifies whether a new transaction data event has been received. New data events identified in step 210 may include identifying that a product has just been sold or ordered. When a new transaction has not been received, program flow may move back to step 210. When a new transaction has been received, program flow may move to determination step 220 that identifies whether the new transaction is associated with a product that is being sold a first time via an MLM organization, when yes program flow moves to step 260 that is discussed below.

When determination step 220 identifies that the new transaction is not associated with a first time that a particular product has been sold, program flow may move to step 230 where transaction data associated with selling the product are retrieved. Here the new transaction and the retrieved product transaction data may identify a number of sales of a particular product. For example a number of sales of a Dremel model 4000 rotary tool may be identified. This transaction data may identify a number of sales of the product over a time frame or may identify a sales rate of the product. The transaction and threshold data may be retrieved from a database accessible by an administration computer. After step 230, threshold data may be retrieved in step 240. The threshold data retrieved in step 240 may be used to identify whether a number of sales of the product has met a level where a new group associated with selling the product should be created or where other actions may be taken relating to meeting or exceeding the sales threshold.

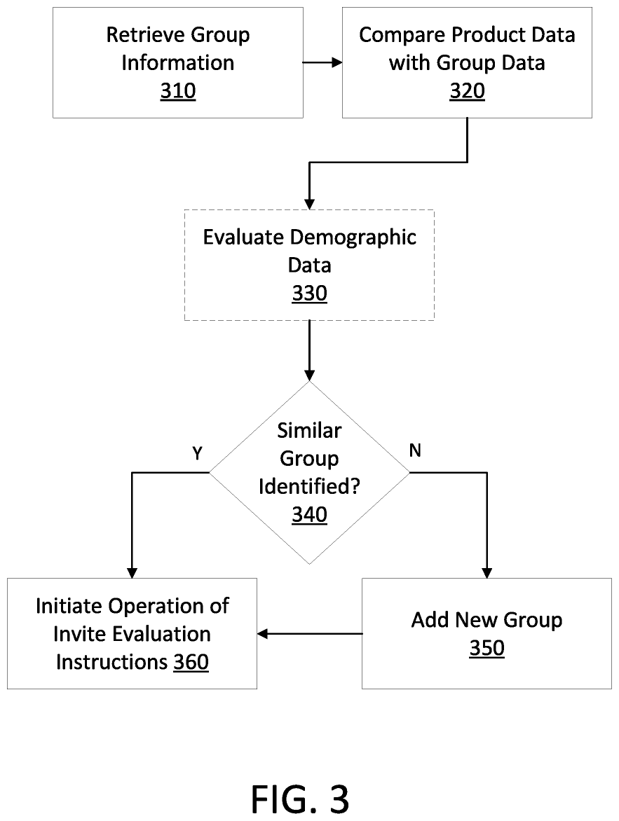

Determination step 250 may then identify whether a sales transaction threshold has been met. Exemplary transaction thresholds include a total number of pieces sold of a particular product (e.g. 1000 power drills), a number of products sold in a time period (e.g. 100 power drills in a day), a sales growth rate (e.g. an increase in sales rates of 125% over a week), and sales associated with a particular user or user popularity. When determination step identifies that a threshold has at least been met, program flow may move to step 260 where a new group of users may be setup. Setting up new user groups when sales of a particular product meet a threshold may allow data associated with a certain group to more easily be evaluated. Note that FIG. 2 illustrates that an evaluation identifying whether a new group should be created can be performed when a new transaction is associated with a first time that a product was sold via an MLM organization (after step 220) or after a transaction threshold has been met (after step 250). Steps that may be performed when the need for a new group is evaluated are illustrated in FIG. 3 of this disclosure.

When determination step 250 identifies that a transaction threshold has not been met, program flow may move to step 270 where invitations to join a group may be sent to user devices. Program flow may also move to step 270 after step 260. These invitations may invite a new user to join a group. For example when a new transaction is initiated by a user that does not belong to a group or when a user purchases a product not previously sold by the MLM organization, a user may be asked to join a group that was previously established. The group that the user is asked to join may be a group that is currently selling that particular product or the user may be asked to join a newly created group. Invites may also be sent requesting that others join a new or existing group. These invites may be sent from a computer to user devices that belong to users or members of a social media group. Users that are sent invites to join a particular group may be identified based on characteristics that different users have in common. This may include, for example, comparing demographic or profile information, such as age, sex, profession, residence zip code, activities that the users like to participate in.

Invitations sent to new users or to other users are not limited to asking particular users to join a group as these new or other users may be sent offerings to purchase a product that is related to a product that has just been purchased. When a particular product is sold, a new user or other users that also purchased the product may be sent invitations via their respective devices to purchase products that can be used with that particular product. For example, when a newly purchased product is a drill, a device that belongs to the person that purchased that product may be sent an offering to purchase drill bits. Since the drill bits may be used with the drill, the drill and the drill bits are related products. These products are related because the drill bits enhance the function of the drill, without drill bits, a drill could not be used to drill a hole.

After step 270, program flow may move to step 280 where stored data may be updated. Updates to the stored data may include incrementing a number of sales of a particular product, decrementing a number of sales when a product is returned, storing data that identifies a new group, storing data that identifies users that belong to specific groups, or may include storing other data. After step 280, program flow may move back to determination step 210 where additional transaction event data may be received.

Table 2 illustrates data that cross-references social media group names with products, types or categories of products, and user data files. The data of table 2 identifies that a group name do it yourself (DIY) carpentry—drill is associated with a product of a power drill and a product category of power tools. Table 2 also indicates that users of the DIY carpentry group are listed in a datafile entitled PDUsers.dat. Table 2 also cross-references other groups, products, product categories, and user datafiles: group cold treatments is associated with a cold medicine, a category of pharmacy, and user datafile CMUsers.dat; group KIY carpentry—power saws is associated with a table saw product, a power tools product category, and user datafile TSUsers.dat; and Hemo Décor—living room group is associated with a couch product, a furniture product category, and a user data file of LRUsers.dat.

When performing operations consistent with the present disclosure, an administration computer may access the data of table 2 to identify a group name, products sold by that group, categories of products, and users of that group. The administration computer may use this information to send invites to the users to purchase products or may send invitations to other users to join a particular group.

The data of table 2 may be stored at a social media group database that is accessible by an administration computer. This social media database may store numerous other attributes that relates to selling products or that relate to product transactions. This information could also be used as criteria for creating new groups. In certain instances, a large product category, such as a power tools category may include more tools than just a power drill as a power tools category data could include information relating to table saws, power sanders, or other tools.

A first power tools category could be more or less specific than another power tools category. For example, a general power tools category could include tools relating to woodworking, machine tools, and gardening tools, where a more specific category could include tools relating to just woodworking. Users may send invites to their friends or other users such that new users can be added to a group. For example, users of a woodworking group could send invites to users of a gardening tools group inviting them to join the woodworking group. New sales generated by these invites could result in commissions being paid to one or related members associated with the invitations sent to other users based on each respective user of a chain of users purchasing a particular product. Alternatively or additionally, invitations to join a group could be sent to user devices automatically based on a characteristic associated with a product or based on matching demographic data.

TABLE 2
Social Media Database Data

| | | Product | |
|---|---|---|---|
| Group Name | Product | Category | Users |
| DIY Carpentry-Drill | Power Drill | Power Tools | PDUsers.dat |
| Cold Treatments | Cold | Pharmacy | CMUsers.dat |
| | Medicine | | |
| KIY Carpentry- | Table Saw | Power Tools | TSUsers.dat |
| Power Saws | | | |
| Home Décor-Living | Couch | Furniture | LRUsers.dat |
| Room | | | |

Table 3 illustrates data that may be stored in a database accessible by an administration network computer that stores transaction data. The data of table 3 identifies dates and times when a particular product was purchased by a particular user, the particular user here is identified by a user identifier (ID). By identifying a user by a user ID, the identity of the user may be hidden from a casual observer. This user ID may be cross-referenced by data included in a different database or may be stored at a different part of a same database. The data of table 3 also identifies a group that the user belongs to. The data of table 3 identifies that a power drill was purchased on Jan. 5, 2020 at eight in the morning (0800) by user ID 12345 who is a member of the power tools product group. The data of table 3 also identifies that a couch was purchased on May 25, 2020 at twenty minutes after nine in the evening (2120) by user ID 73823 who is a member of the furniture—living room product group.

Data stored at a social media transaction database may include a record of each transaction processed through a MLM organization. While the data illustrated in table 3 includes a transaction date/time, a product, a product group, and user ID, other data that could be stored a social media transaction database may include, a code that a user used to receive a discount, an outlet through which the product was sold, a geolocation of the user, or other data. This data may allow an administration computer to identify when a new social media group should be created and allows users who should or could be invited to join a group be sent invites based on previous transactions or demographic data associated with these users. Users that purchase a living room end table may be invited to join the furniture group and may receive offerings to purchase a couch or other piece of furniture. Such offerings may be received by way of invitations from other users or may be generated automatically. In certain instances, marketing materials generated by a user that has a track record of significantly influencing others to purchase certain products may be given priority over marketing materials created by less successful user.

TABLE 3
Transaction Database Data

| Transaction | | | |
|---|---|---|---|
| Date/Time | Product | Product Group | User ID |
| Jan. 5, 2020 | Power Drill | Power Tools | ID12345 |
| 0800 | | | |
| Jan. 5, 2020 | Table Saw | Power Tools | ID12456 |
| 0850 | | | |
| Jan. 5, 2020 | Cold | Medications | ID34567 |
| 0925 | Medicine | | |
| May 25, 2020 | Couch | Furniture-Living | ID73823 |
| 2120 | | Room | |

Table 4 illustrates data that may be stored in a group rules database accessible by an administration network computer. The data of table 4 cross-references rule criteria, product types, and a group creation thresholds. Note that the rule criteria of table 4 includes a total sales value or number, a total sales in a twenty four hour period of time, a sales growth rate, and single ad redemption criteria. Each of these criteria are associated with a particular product and with a particular threshold. Table 4 indicates that a drill product is associated with three types of rule criteria and three different thresholds. Here the drill product is associated with a total group creation threshold of the drill of 1000 units (pieces), a sales in twenty four hours product group creation threshold of 100 drill units, and a sales growth rate for the drill product group creation threshold of 125% over a time period (e.g. a day, a week, or week to week). Table 4 also indicates that a cold medicine product sold via a single advertisement is coupled to a group creation threshold of 100 units.

TABLE 4
Group Rules Database Data

| | | Group Creation | |
|---|---|---|---|
| Rule Criteria | Product | Threshold | |
| Total Sales | Power Drill | 1000 | units |
| Sales in 24 Hours | Power Drill | 100 | units |
| Sales Growth Rate | Power Drill | 1.25 | |
| Single Ad | Cold | 100 | units |
| Redemption | Medicine | | |

Social media group creation thresholds can also include criteria based upon success of selling or attributes associated with user that purchased a product. The appearance and identification of a micro-influencer may be someone who has had their advertising code used to purchase the cold medicine of table 4 more than 100 times. At this point in time, the user identified as a “micro-influencer” may be allowed to become a leader of a new group and materials used or developed by this micro-influencer may be shared with members of the new group in order to generate additional sales of the cold medicine. Sales generated by the micro-influencer or that person's marketing materials may result in commissions being distributed to the micro-influencer. Bonuses may also be provided to the micro-influencer for generating a threshold number of sales.

Thresholds stored in the group rules database may have been set by an administrator that controls the administration computer or may be set by administrators of a third party network computer. In certain instances, attributes of individuals could be used in place of, or in addition to the criteria already listed for creating a new social media group. For example, the criteria for creating a social media group for power drills might be 1000 drills sold to users who live in a rejoin or state (e.g. the New England rejoin).

FIG. 3 illustrates steps that may be performed when a determination relating to whether a new group of a multilevel marketing (MLM) social media sales organization should be created. FIG. 3 begins with step 310 where group information is retrieved or accessed. This may include accessing a database that stores information that identifies groups, group members, and products currently sold by that group. After step 310, program flow may move to step 320 where product data is compared to group data. Criteria for creating a group may include the determination made in step 250 of FIG. 2 that identified that the transaction threshold was met. In some instances, the meeting of the threshold may be enough of a reason to establish the new group. In other instances, a rule may identify other criteria should be evaluated before a new group is created. For example, a rule may identify that both the threshold may need to be met and that a new group should be created only when a threshold number of users of a same demographic are available to be invited to join the new group.

In other instances, rules may specify a maximum number of users that a group should include and may specify that a new group should not be established until all groups currently selling a product have met a threshold number of users. In such an instance, a new user may receive an invite to join a group that currently has fewer than a maximum number of users. Invitations sent to user devices may include offering information relating to purchasing a product that may be used with a newly purchased product. As discussed above, users that purchased a drill may be provided with offering to purchase drill bits.

Criteria for creating a new group may also vary based on a type of threshold that is met. For example, different actions may be performed when a threshold of a number of sales threshold is met as compared to the meeting of a threshold associated with a growth rate. Certain rules may also force different groups to be combined, for example when the number of sales threshold is met by a first group may cause the first group that sells a first product be merged with a second group that does not sell that first product. This may help members of the first group sell the product because each of the members of the first group may have already had an opportunity to purchase the product. As such, groups like the first group may be merged with the second group when sales of the first product to members of the first group have saturated.

Thresholds may be set by individuals that control the administration network computer or may be set based on requirements received from a third party computer. These thresholds may define for the system rules for creating a group. For example, transaction data for power drills that meets a rule may result in a new group being formed. These rules may be stored in a database 125 accessible by administration computer 105 of FIG. 1. For example, these rules may be stored in an administration network group rules database. In instances when a power tools social media group already exists in the administration network group rules database, a new group may not be created, instead purchasers of the drill may be sent an invite to a general power tools group.

Rules for creating groups may also evaluate how similar an existing group is. When an existing group is judged to be similar enough, new purchasers of a product may be asked to join the existing group instead of being included in a new group. For example, purchasers of a sea kayak may be asked to join a river kayak group or a row boat group based on each of these boats being powered by oars manipulated by people according to a rule that links water craft by how the water craft is powered. Alternatively, purchasers of the sea kayak may be asked to join groups that sell surf boards based on rules that link watercraft made to be used in the ocean. Alternatively, individuals that purchased the sea kayak could be placed into a new group. In yet other instances, purchasers of the sea kayak could be placed into multiple groups according to rules, a new group could be made from an existing group, or groups may be merged based on rules stored at the database.

Purchasers of a particular product could be separated from a larger group when a number of members reach a certain criteria. For example, a group that includes skiers and snowboarders could be separated into two separate groups after a number of snowboarders in the original group reaches a threshold number of 10. This would allow the snowboarders to receive product offerings that are more focused to snowboarding. Here the snowboarders could be sent or could share advertisements related to a new snowboard boot. This would prevent skiers from receiving product offering information for products that they would likely not be interested in as skiers would typically never use snowboard boots.

Rules could also be used to filter types of product offerings sent to certain members of a group based on common criteria that identifies a commonality between otherwise disparate group members. For example, while skiers may not be sent offerings to purchase snowboard boots because of information that identifies that snowboard boots are not useful to skiers, these skiers may be sent wax that can be used either on skis or snowboards based on information that identifies that the wax is commonly used by both snowboarders and skiers.

After step 320, program flow of FIG. 3 moves to step 330 where demographic data or other information relating to users may be evaluated. This demographic data may include information that identifies age, sex, profession, residence zip code, activities that the users like to participate in, or other information that may be used identify commonalities or differences between users. Demographic data that identifies one user as a skier and another user as a snowboarder could be used to create groups or identify which product offering, referrals, or recommendations that would be shared with other group members.

After the demographic data is evaluated in step 330, program flow may move to determination step 340, that may identify whether a similar group exists, when no, program flow may move to step 350 where a new group may be added. When determination step 340 identifies that a similar group has been identified, program flow may move to step 360, where invitations may be sent to a new user or to other users to join the similar group. Program flow may also move to step 360 after a new group is added in step 350. Here again invites may be sent to the new user and possibly to other users that share some a common attribute or a piece of demographic data. As mentioned above, invitations sent to user devices may be invites to join a group or to purchase particular products.

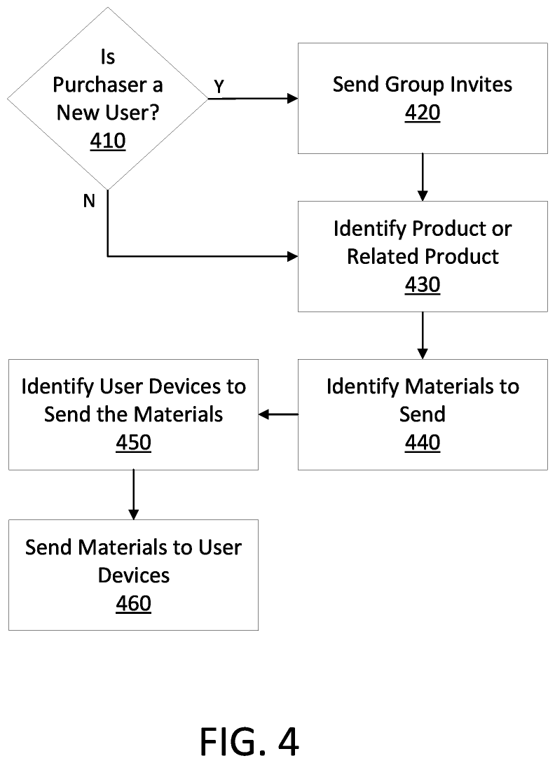

Note that several different groups could exist that share certain attributes. Groups related to winter may include waterproof winter clothing, skiers, and snowboarders. Each of these groups may be judged similar enough to include the same members. When a threshold level of sales occurs or when a threshold number of users that share a same attribute is met, a new group could be created. This may include sending invites to specific members to join the new group. These members may also be allowed to belong to an original group. Each of these actions may be controlled by the use of thresholds, rules, and attribute or demographic data. After step 360 of FIG. 3, program flow may move to step 270 of FIG. 2 that may perform steps illustrated in FIG. 4.

FIG. 4 illustrates a series of steps that may be performed when evaluations are performed that identify whether invitations should be sent to user devices of present users or new users of a multilevel marketing (MLM) organization. These invitations may invite users to join specific groups or may invite users to purchase products. FIG. 4 begins with determination step 410 that identifies whether a new transaction to purchase a product was received from a new user, when yes program flow moves to step 420 where invites to join a new group or an existing group are sent to a user device of the new user. Step 420 may also include sending invites to other user devices based on a rule or shared demographic data. The groups that the users are invited to join may be the group identified in step 340 of FIG. 4 or the new group added in step 350 of FIG. 3.

When determination step 410 identifies that the new transaction to purchase the product was not received from a new user or after step 420, program flow moves to step 430 where the product or a related product may be identified. When the product is purchased by a new user of a multilevel (MLM) marketing organization, information relating to that product may be identified in step 430. Alternatively, or additionally products related to the newly purchased product may be identified in step 430. Here, related products may be products that may be used with the newly purchased products, such as oars that may be used with a kayak, ski bindings that may be installed on skis, boots that may be used with a snowboard, or drill bits that may be used with a drill. This process may include receiving a prompt or data from a social media group database to invite users who purchased the same product. All transactions related to product(s) associated with a particular social media group, such as all purchases of the power drill discussed above may be identified in step 430. After step 430, materials that may be included in invitations sent to user devices may be identified in step 440. These materials may be an advertisement that is associated with a successful follow on sales of a product or a related product. For example, sales materials that have a successful follow in sales rate of ⅔ may be shared with other user devices instead of sales materials that have a successful follow on sales rate of less than ⅔. This ⅔ rate may have been calculated based on the fact that 30 invites sent to user devices resulted in the sale of 20 products.

This process may include receiving a prompt or data from a social media group database to invite users who purchased the same product. All transactions related to product(s) associated with a particular social media group, such as all purchases of the power drill discussed above may be identified in step 430 of FIG. 4. From that purchase data, a most frequently used advertisement used to sell the product or the related product may be identified. This identification may be based on the number of times a particular code was used in an invitation message. Such invitation messages may have been shared by a text message or email, for example.

Next in step 450 of FIG. 4, user devices to send these materials to may be identified. In instances when users of those user devices are already members of a particular social media group, the materials may be sent to those user devices in step 460. In instances when identified marketing materials are sent to user devices of members of a new group, the messages may be sent to all user devices associated with that new group in step 460. After step 460 of FIG. 4, program flow may move to step 280 of FIG. 2 where stored data may be updated.

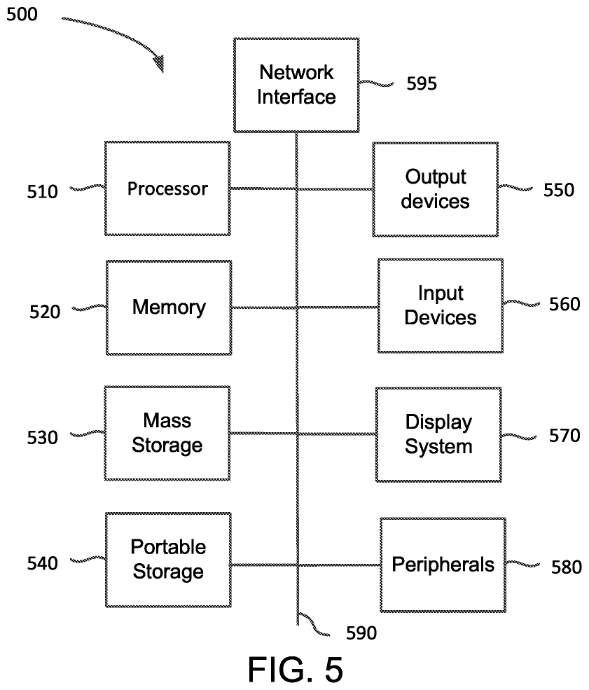

FIG. 5 illustrates a computing system that may be used to implement an embodiment of the present invention. The computing system 500 of FIG. 5 includes one or more processors 510 and main memory 520. Main memory 520 stores, in part, instructions and data for execution by processor 510. Main memory 520 can store the executable code when in operation. The system 500 of FIG. 5 further includes a mass storage device 530, portable storage medium drive(s) 540, output devices 550, user input devices 560, a graphics display 550, peripheral devices 580, and network interface 595.

The components shown in FIG. 5 are depicted as being connected via a single bus 590. However, the components may be connected through one or more data transport means. For example, processor unit 510 and main memory 520 may be connected via a local microprocessor bus, and the mass storage device 530, peripheral device(s) 580, portable storage device 540, and display system 550 may be connected via one or more input/output (I/O) buses.

Mass storage device 530, which may be implemented with a magnetic disk drive—an optical disk drive—or FLASH memory, is a non-volatile storage device for storing data and instructions for use by processor unit 510. Mass storage device 530 can store the system software for implementing embodiments of the present invention for purposes of loading that software into main memory 520.

Portable storage device 540 operates in conjunction with a portable non-volatile storage medium, such as a FLASH memory, compact disk or Digital video disc, to input and output data and code to and from the computer system 500 of FIG. 5. The system software for implementing embodiments of the present invention may be stored on such a portable medium and input to the computer system 500 via the portable storage device 540.

Input devices 560 provide a portion of a user interface. Input devices 560 may include an alpha-numeric keypad, such as a keyboard, for inputting alpha-numeric and other information, or a pointing device, such as a mouse, a trackball, stylus, or cursor direction keys. Additionally, the system 500 as shown in FIG. 5 includes output devices 550. Examples of suitable output devices include speakers, printers, network interfaces, and monitors.

Display system 550 may include a liquid crystal display (LCD), a plasma display, an organic light-emitting diode (OLED) display, an electronic ink display, a projector-based display, a holographic display, or another suitable display device. Display system 550 receives textual and graphical information and processes the information for output to the display device. The display system 550 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 580 may include any type of computer support device to add additional functionality to the computer system. For example, peripheral device(s) 580 may include a modem or a router.

Network interface 595 may include any form of computer interface of a computer, whether that be a wired network or a wireless interface. As such, network interface 595 may be an Ethernet network interface, a BlueTooth™ wireless interface, an 802.11 interface, or a cellular phone interface.

The components contained in the computer system 500 of FIG. 5 are those typically found in computer systems that may be suitable for use with embodiments of the present invention and are intended to represent a broad category of such computer components that are well known in the art. Thus, the computer system 500 of FIG. 5 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer can also include different bus configurations, networked platforms, multi-processor platforms, etc. The computer system 500 may in some cases be a virtual computer system executed by another computer system. Various operating systems can be used including Unix, Linux, Windows, Macintosh OS, Palm OS, Android, iOS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a FLASH memory/disk, a hard disk, magnetic tape, any other magnetic medium, a CD-ROM disk, digital video disk (DVD), any other optical medium, RAM, PROM, EPROM, a FLASH EPROM, and any other memory chip or cartridge.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The functions performed in the processes and methods which may be implemented in differing order. Furthermore, the outlined steps and operations are only provided as examples, and some of the steps and operations which may be optional, combined into fewer steps and operations, or expanded into additional steps and operations without detracting from the essence of the disclosed embodiments.

What is claimed is:

1. A method for selling products, the method comprising:
identifying that a user has provided authorization to purchase a product, the authorization received from a user device of the user;
comparing product sales data of the product with product sales threshold data associated with the product;
identifying that a sales threshold has been met after comparing the product sales data with the product sales threshold data;
sending an invitation to the user device that includes a social media group that the user can join, the social media group identified according to a group assignment rule based on the meeting of the sales threshold; and
receiving a data from the user device indicating that the user has agreed to join the social media group, wherein the user is associated with the social media group according to the group assignment rule and the product is provided to the user based on the authorization to purchase the product.

2. The method of claim 1, further comprising identifying that a characteristic of the user is consistent with demographic data of the social media group, wherein the social media group is also identified based on the characteristic of the user being consistent with the demographic data of the social media group.

3. The method of claim 1, further comprising:
receiving information that associates the product with a second product;
identifying members of the social media group that purchased the product; and
sending a purchase invitation to user devices of the identified social media group members, the purchase invitation including an offering to purchase the second product, wherein the purchase invitation is sent based on the identified members purchases of the product and the information that associates the product with the second product.

4. The method of claim 3, further comprising identifying that a first advertisement is associated with a greater number of sales of the second product than a second advertisement, wherein the purchase invitation includes the first advertisement based on the identification that the first advertisement is associated with the greater number of sales of the second product than the second advertisement.

5. The method of claim 1, further comprising collecting user demographic data of members of the social media group.

6. The method of claim 5, further comprising:
identifying an association of the user demographic data with the product; and
sending a purchase invitation to purchase the product to user devices of the members of the social media group based on the association between the user demographic data and the product.

7. The method of claim 1, further comprising:
receiving an indication that a member of the social media group has ordered the product, the indication identifying a code included in a purchase invitation to purchase the product;
identifying that the code corresponds to the purchase invitation; and
authorizing distribution of commissions for receipt by a particular user based on the code being associated with the particular user.

8. The method of claim 7, wherein the commissions are distributed for receipt by the particular user after the order of the product has been fulfilled.

9. The method of claim 1, further comprising updating stored sales metric data that corresponds to the sales threshold after identifying that the user authorized the purchase of the product.

10. The method of claim 1, further comprising identifying that a new group should be created based on the identification of the sales threshold being met, wherein the new group is the social media group.

11. The method of claim 1, further comprising:
identifying that the product is a new product sold in association with a multilevel (MLM) organization;
sending an additional invitation to an additional user device inviting a second user to join the social media group; and
receiving authorization from the additional user device authorizing the second user to join the social media group according to the additional invitation.

12. The method of claim 11, further comprising:
associating marketing materials for purchasing the new product with the user;
sending a purchase invitation to the second user to purchase the new product;
receiving an indication that the second user has authorized purchase of the new product; and
authorizing distribution of commissions for receipt by the user based on the marketing materials being associated with the user.

13. A non-transitory computer-readable storage medium having embodied thereon a program executable by a processor for implementing a method for selling products, the method comprising:
identifying that a user has provided authorization to purchase a product, the authorization received from a user device of the user;
comparing product sales data of the product with product sales threshold data associated with the product;
identifying that a sales threshold has been met after comparing the product sales data with the product sales threshold data;
sending an invitation to the user device that includes a social media group that the user can join, the social media group identified according to a group assignment rule based on the meeting of the sales threshold; and
receiving a data from the user device indicating that the user has agreed to join the social media group, wherein the user is associated with the social media group according to the group assignment rule and the product is provided to the user based on the authorization to purchase the product.

14. The non-transitory computer-readable storage medium of claim 14, the program further executable to identify that a characteristic of the user is consistent with demographic data of the social media group, wherein the social media group is also identified based on the characteristic of the user being consistent with the demographic data of the social media group.

15. The non-transitory computer-readable storage medium of claim 13, the program further executable to:
receive information that associates the product with a second product;
identify members of the social media group that purchased the product; and
send a purchase invitation to user devices of the identified social media group members, the purchase invitation including an offering to purchase the second product, wherein the purchase invitation is sent based on the identified members purchases of the product and the information that associates the product with the second product.

16. The non-transitory computer-readable storage medium of claim 15, the program further executable to identify that a first advertisement is associated with a greater number of sales of the second product than a second advertisement, wherein the purchase invitation includes the first advertisement based on the identification that the first advertisement is associated with the greater number of sales of the second product than the second advertisement.

17. The non-transitory computer-readable storage medium of claim 13, the program further executable to collect user demographic data of members of the social media group.

18. The non-transitory computer-readable storage medium of claim 17, the program further executable to:
identify an association of the user demographic data with the product; and
send a purchase invitation to purchase the product to user devices of the members of the social media group based on the association between the user demographic data and the product.

19. The non-transitory computer-readable storage medium of claim 13, the program further executable to:
receive an indication that a member of the social media group has ordered the product, the indication identifying a code included in a purchase invitation to purchase the product;
identify that the code corresponds to the purchase invitation; and
authorize distribution of commissions for receipt by a particular user based on the code being associated with the particular user.

20. The non-transitory computer-readable storage medium of claim 19, wherein the commissions are distributed for receipt by the particular user after the order of the product has been fulfilled.
